(19) United States
(12) Patent Application Publication
(10) Pub. No.: US 2026/0292706 A1
(43) Pub. Date: Sep. 24, 2026

(54) SYSTEMS AND METHODS FOR ADAPTIVE RESOURCE CONTROL IN RADIO ACCESS NETWORKS

(71) Applicant: Verizon Patent and Licensing Inc., Basking Ridge, NJ (US)

(72) Inventors: John Joseph Cooke, Algonquin, IL (US); Shuang Echo Yang, Naperville, IL (US); Cindy Yuexin Dong, Bridgewater, NJ (US); Xin Wang, Morris Plains, NJ (US)

(21) Appl. No.: 19/084,931

(22) Filed: Mar. 20, 2025

(51) Int. Cl. H04W 52/24; H04W 72/044; H04W 72/54

(52) U.S. Cl. CPC H04W 52/24; H04W 72/046; H04W 72/0473; H04W 72/54

(57) ABSTRACT

A method, a network device, and a non-transitory computer-readable storage medium are described in relation to an adaptive resource control service. The service may include monitoring power consumption data of transmit antennas for zones in a cell segment and identifying that the cell segment has an average power consumption above a first threshold. The service may also include identifying a first zone, of the zones in the cell segment, having a highest current power consumption and assigning priority levels to end devices within the first zone. Over a next scheduling period, the service may reduce resource allocations to end devices with a lowest priority level.

### BACKGROUND

Development and design of networks create new service opportunities from a network-side perspective and an end device perspective. With respect to Next Generation (NG) wireless networks, such as Fifth Generation New Radio (5G NR) networks, various mechanisms and technologies may be used to ensure the delivery of certain performance metrics, such as minimal latency and packet loss, as well as high throughput and other types of network performance criteria. Regulatory requirements, such as power limits, can sometimes present a challenge in meeting these performance metrics.

### BRIEF DESCRIPTION OF THE DRAWINGS

FIGS. 1A and 1B illustrate concepts described herein;

FIG. 2 is a diagram illustrating an exemplary environment in which an embodiment of an adaptive resource control service may be implemented;

FIG. 3 is a diagram illustrating an architecture for adaptive resource control based on artificial intelligence (AI)/machine learning (ML), according to an implementation;

FIGS. 4A and 4B are diagrams illustrating communication among network devices to implement modeling for the adaptive resource control service;

FIG. 5 is a diagram illustrating an exemplary process of an embodiment of the adaptive resource control service;

FIG. 6 is a diagram illustrating components of a device that may correspond to one or more of the devices illustrated and described herein; and

FIG. 7 is a flow diagram illustrating an exemplary process of another embodiment of the adaptive resource control service.

### DETAILED DESCRIPTION

The following detailed description refers to the accompanying drawings. The same reference numbers in different drawings may identify the same or similar elements. Also, the following detailed description does not limit the invention.

A wireless network, such as a 5G network, may offer various frequency bands, carriers, radio frequencies (RFs), and/or another type of segment of radio spectrum (simply referred to as radio frequency) that an end device may use for connectivity to an application service. The end device may establish and/or connect to the application service via a packet data unit (PDU) session, a network slice, a quality of service (QoS) flow, or the like, and a selected radio frequency.

In 5G NR, advanced beamforming techniques may be used to improve network coverage and capacity. Power limits, among other factors, provide a constraint on services that can be achieved with advanced beamforming techniques. For example, Effective Isotropic Radiated Power (EIRP) of transmit antennas is governed by regulatory requirements that set boundaries (e.g., time limits, magnitude, etc.) on the strength of radio frequency (RF) transmissions. More particularly, EIRP limits may be set for individual segments within a cell or sector.

Advanced beamforming techniques may increase the peak EIRP, such that power limits are imposed according to regulatory requirements. Thus, efficient use of Radio Access Network (RAN) energy includes maximizing the network capacity and coverage under the EIRP limit, securing user experience, and improving the cell general performance at the same time. In most cells, users are not evenly distributed within the cell's geographical footprint. Directional power/performance monitoring and control make it possible to adapt the power consumption and time-frequency resource usage independently for individual zones of the cell to maximize the cell overall performance. In addition to EIRP limits, other constraints may restrict a service provider's ability to provide service to end devices within a designated cell coverage area. For example, cell density, transient sources of signal interference, other regulated power limits, and the like may also present occasions where RAN resources may need to be adapted to maximize network coverage/capacity.

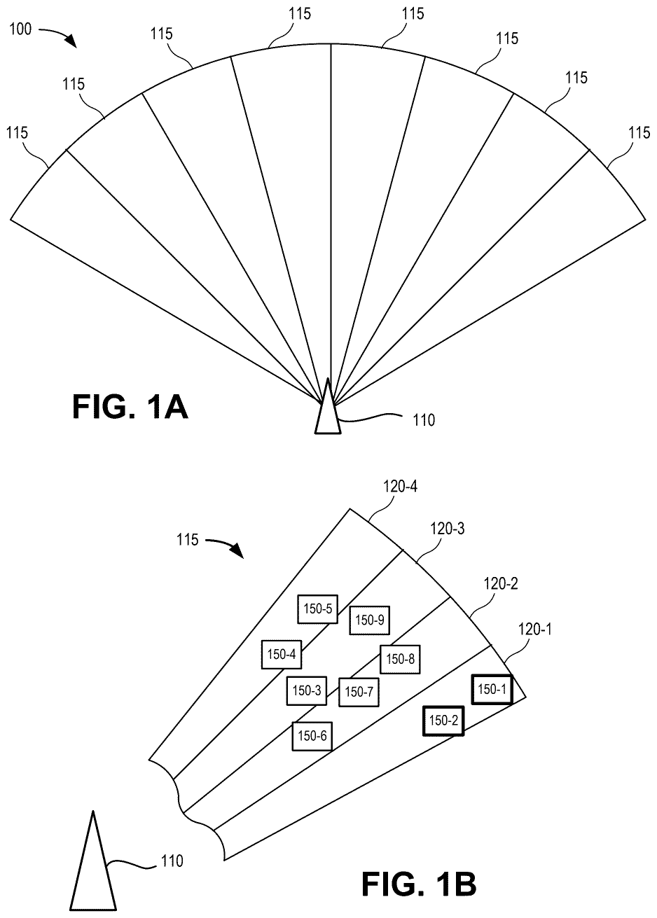

FIGS. 1A and 1B illustrate concepts described here. Referring to FIG. 1A, a wireless access station 110, such as a Next Generation Node B (gNB), may include one or multiple sectors 100 or of a cell. Access station 110 may provide wireless access service for UE devices located within the geographic area of sector 100. Depending on the implementation, wireless access station 110 may provide the wireless access service at a cell, a sector, a sub-sector/segment, carrier, and/or other configurable level. According to one implementation, a sector 100 may be divided into multiple segments 115, such as the eight segments 115 shown. Each segment 115 may be regulated by EIRP limits that set limits on, for example, the average transmit antenna power used over a time period (e.g., any 30 minute interval).

Referring to FIG. 1B, access station 110 may further divide segments 115 into smaller sub-segments or zones 120-1 to 120-4 (referred to herein as collectively as zones 120 and generically as zone 120). Zones 120 may provide cellular service resources to various end devices, such as end devices 150-1 to 150-9 illustrated in FIG. 1B (referred to herein collectively as end devices 150 and generically as end device 150). In one implementation, a zone 120 may be considered a logical combination of beam groups or a sub-coverage area that wireless access station 110 can define. For example, a zone level may include multiple divisions of a geographic area of a segment 115 relative to wireless access station 110. In the example of FIG. 1B, a segment 115 with a 15 degree radius may be divided into four zones 120, each with about a 3.75 degree radius. As another example (not illustrated), a segment 115 may be divided into zones 120 based on proximity to the antenna of wireless access station 110 (e.g., near, mid, far) and/or other criteria. The size and/or shape of each zone 120 may be configurable. The size and/or the shape of a zone 120 may depend on the type of wireless access station 110 (e.g., small cell device versus gNB, etc.), attributes of wireless access station 110 (e.g., antenna configuration, radio frequency band of beam, etc.), and/or other factors (e.g., terrain of the radio covered locale).

Unified distribution of power across different zones 120 (e.g., each of zones 120-1 through 120-4 uses one-fourth of the total segment 115 power) is a basic but low efficiency method to allocate power considering most of the time users are not evenly distributed under a sector/segment footprint. Thus, wireless access station 110 may control segments 115 and/or zones 120 such that adjustments to their configurations can be actively implemented to increase/reduce power loads to improve coverage and/or meet certain usage scenario thresholds. For example, working within the assigned EIRP for a segment 115, a scenario may be enacted to reduce the EIRP of a transmit antenna power for an individual zone 120, which in turn results in more available antenna power for other zones 120 or reduced overall power consumption for segment 115.

Systems and methods described herein provide an adaptive resource control service for RAN devices. The adaptive resource control service may be based on time domain, frequency domain (bandwidth), or power limitation and uses directional power and performance monitoring capabilities to maximize network coverage/capacity within regulated power, time, and frequency limits. For example, if the peak EIRP in one zone 120 is close to the designated limit, the adaptive resource control service may skip some time slot resource allocation for end devices 150 in that zone 120 to reduce the peak power for that zone.

For example, assume zone 120-1 has a high power draw over several minutes and the adaptive resource control service may skip some time slot resource allocation for end devices 150-1 and/or 150-2. Such skips/delays in scheduling may potentially impact certain time critical applications executed on end devices 150-1 or 150-2 in zone 120-1, while enabling acceptable service levels to other end devices in segment 115. Accordingly, the adaptive resource control service may use an adaptive resource control method, such that the network counts the time-frequency resources for each zone 120 independently over every radio frame or predefined periodicity, while making sure the scheduler of wireless access station 110 does not allocate more power than the regulated threshold for the long-term average of each zone (e.g., the EIRP limit). The adaptive resource control service may give higher priority to the time critical applications on end devices 150-1 and/or 150-2 in the zone 120-1 to secure the user experience for that zone in the next scheduling period.

In a similar use case, zone 120-4 could be utilizing a significant portion of Physical Downlink Channel (PDCCH) resources for end devices 150-5 and 150-4. The adaptive resource control service may limit time domain resources for this zone 120-4 to increase overall sector performance for the remaining footprint of sector 115.

In other implementations, the adaptive resource control service may add power domain adaptation as a third dimension on the top of time-frequency resource control. For example, when an end device 150 reports strong signals, the adaptive resource control service may apply power spectral density (PSD) reduction to reduce wasted time-frequency resources while minimizing the impact on user experience.

According to an embodiment, the adaptive resource control service may use artificial intelligence and/or machine learning (AI/ML) logic to optimize power distribution within a segment (e.g., segment 115). For example, the AI/ML logic may obtain power consumption, resource usage, and end device performance from each zone 120 and prioritize end devices 150 based on (a) performance (e.g., data transmission performance such as downlink throughput, etc.) for the end device 150 from a previous (e.g., most recent) scheduling period and/or (b) data demand and latency requirements from the end device 150. In one implementation, the adaptive resource control service may dynamically modify scheduling information (e.g., to skip a time slot, reduce resource block allocation, etc.) in real time or near-real time according to various types of criteria or objectives, as described herein. For example, the criteria may include an average power consumption threshold, user defined performance or capacity criteria (e.g., processor occupancy, uplink interference, user perceived throughput, PUCCH and PDCCH utilization, etc.), and/or another configurable parameter or factor.

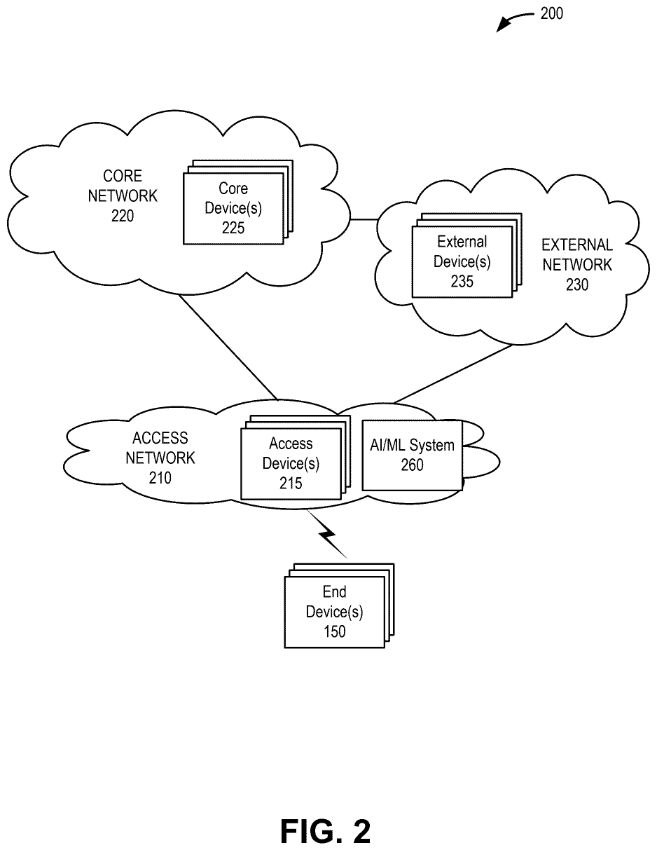

FIG. 2 is a diagram illustrating an environment 200 in which an exemplary embodiment of an adaptive resource control service may be implemented. As illustrated, environment 200 includes an access network 210, a core network 220, and an external network 230. Access network 210 includes access devices 215 (also referred to individually or generally as access device 215), which may correspond to access device 110 of FIGS. 1A and 1B. Core network 220 includes core devices 225 (also referred to individually or generally as core device 225). External network 230 includes external devices 235 (also referred to individually or generally as external device 235). Environment 200 further includes end devices 150 (also referred to individually or generally as end device 150) and an artificial intelligence (AI)/machine learning (ML) system 260.

The number, type, and arrangement of networks illustrated in environment 200 are exemplary. For example, according to other embodiments, environment 200 may include fewer networks, additional networks, and/or different networks. For example, according to other embodiments, other networks not illustrated in FIG. 2 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 200 includes communication links between the networks and between the network devices. Environment 200 may be implemented to include wired, optical, and/or wireless communication links. A communicative connection via a communication link may be direct or indirect. For example, an indirect communicative connection may involve an intermediary device and/or an intermediary network not illustrated in FIG. 2. A direct communicative connection may not involve an intermediary device and/or an intermediary network. The number, type, and arrangement of communication links illustrated in environment 200 are exemplary.

Environment 200 may include various planes of communication including, for example, a control plane, a user plane (UP), a service plane, and a network management plane. Environment 200 may include other types of planes of communication. A message communicated in support of the adaptive resource control service may use at least one of these planes of communication. According to various exemplary implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 210 may include one or multiple networks of one or multiple types and technologies. For example, access network 210 may be implemented to include a 5G RAN, a future generation RAN (e.g., a 6G RAN, a 7G RAN, etc.), a centralized-RAN (C-RAN), a virtualized RAN (vRAN), an Open-RAN (O-RAN), and/or another type of access network. Access network 210 may include a legacy RAN (e.g., a Third Generation (3G) RAN, a Fourth Generation (4G) RAN, etc.). Access network 210 may communicate with and/or include other types of access networks, such as, for example, a Wi-Fi® network, a local area network (LAN), a Citizens Broadband Radio System (CBRS) network, a cloud RAN, a self-organizing network (SON), a wired network (e.g., optical, cable, etc.), or another type of network that provides access to or can be used as an on-ramp to access network 210 and/or core network 220. In still other implementations, access network 210 may include a non-terrestrial network (NTN), such as a satellite-based network.

Access network 210 may include different and multiple functional splitting, such as options 1, 2, 3, 4, 5, 6, 7, or 8 that relate to combinations of access network 210 and core network 220 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA NR, SA NR, etc.). Additionally, or alternatively, according to some exemplary embodiments, access network 210 may be implemented to include various wired and/or optical architectures for wired and/or optical access services.

Depending on the implementation, access network 210 may include one or multiple types of network devices, such as access devices 215. For example, access device 215 may include a gNB, an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 215 may include a transport device (e.g., a router or similar network device).

Access device 215 may include other types of wireless access devices, such as a Wi-Fi device, a hotspot device, and/or a fixed wireless access customer premise equipment (FWA CPE), etc.) that provides a wireless access service. Additionally, access devices 215 may include a wired and/or an optical device (e.g., modem, wired access point, optical access point, Ethernet device, multiplexer, etc.) that provides network access and/or transport service. According to some exemplary implementations, access device 215 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 215 may include a split access device (e.g., a CU-control plane (CP), a CU-user plane (UP), etc.) or an integrated functionality, such as a CU-CP and a CU-UP, or other integrations of split RAN nodes. Access device 215 may be an indoor device or an outdoor device.

According to various exemplary implementations, access device 215 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 215 may provide a wireless access service at a cell, a sector, a sub-sector/zone, carrier, and/or other configurable level, such as described above in connection with FIGS. 1A and 1B.

According to some exemplary embodiments, at least some of access devices 215, as described herein, include an embodiment of the adaptive resource control service. For example, according to an exemplary embodiment, a CU, a RIC, or similar type of wireless station controller device may include logic of the adaptive resource control service. According to such an embodiment, the DU, RIC, or the like may generate and provide power management and/or scheduling information to another access device 215 (e.g., wireless station, a DU, or the like), as described herein. According to one implementation, AI/ML system 260 may be included in access network 210.

Core network 220 may include one or multiple networks of one or multiple network types and technologies. Core network 220 may include a complementary network of access network 210. For example, core network 220 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 220 may include diverse types of core devices 225. Core devices 225 may include, for example, a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), and/or a network exposure function (NEF). According to one implementation, AI/ML system 260 may be included in core network 220. According to other exemplary implementations, core devices 225 may include additional, different, and/or fewer network devices than those described.

External network 230 may include one or multiple networks of one or multiple types and technologies that provide an application service. For example, external network 230 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 230 may be implemented to include a cloud network, a private network, a public network, a Multi-access Edge Computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 230 may include various network devices, such as external devices 235. For example, external devices 235 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 150. By way of further example, external devices 235 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 230 may include one or multiple types of core devices 225, as described herein.

External devices 235 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services.

End device 150 may include a device that may have communication capabilities (e.g., wireless, wired, optical, etc.). End device 150 may or may not have computational capabilities. End device 150 may be implemented as a mobile device, a portable device, a stationary device (e.g., a non-mobile device and/or a non-portable device), a device operated by a user, or a device not operated by a user. For example, end device 150 may be implemented as a smartphone, a mobile phone, a personal digital assistant, a tablet, a netbook, a wearable device (e.g., a watch, glasses, headgear, a band, etc.), a computer, a gaming device, a music device, an IoT device, a drone, a smart device, an autonomous vehicle, or another type of wireless device (e.g., another type of user equipment (UE)). End device 150 may or may not be configured to execute diverse types of software (e.g., applications, programs, etc.). The number and the types of software may vary among end devices 150. End device 150 may include “edge-aware” and/or “edge-unaware” application service clients. End device 150 may be implemented as a virtualized device in whole or in part. For purposes of description, end device 150 is not considered a network device.

As further shown in FIG. 2, AI/ML system 260 may be included in access network 210. One or more aspects of AI/ML system 260 may be implemented, for example, by an access device 215 (e.g., a RIC device, a BSC, and/or a gNB). According to an exemplary embodiment, at least some of access devices 215 may include logic of an exemplary embodiment of the adaptive resource control service. For example, a RIC, an RNC, a BSC, or similar type of network device that may manage, control, and/or configure a cellular wireless station of access network 210 may provide the aspects of the adaptive resource control service.

According to an exemplary embodiment, AI/ML system 260 may provide optimization models for each zone to implement the adaptive resource control service. For example, AI/ML system 260 may track power consumption, resource usage (e.g., scheduling of resource blocks (RB)), and end device performance for each zone/sub-sector. Power consumption may include, for example, antenna transmit power for each RU 350 associated with a zone 120. Resource usage may include, for example, a Physical Downlink Channel (PDCCH) grant aggregation level (e.g., the number of consecutive Control Channel Elements (CCEs) required to carry a single PDCCH grant) and/or PDCCH slot aggregation for end devices 150 in a zone 120. End device 150 performance may include a downlink (DL) signal strength measurement or another key performance indicator (KPI) reported by end device 150, such as a Reference Signal Received Power (RSRP) value, a Reference Signal Received Quality (RSRQ) value, a Received Signal Strength Indicator (RSSI) value, a Signal to Interference and Noise Ratio (SINR) value, a Channel Quality Indicator (CQI) value, or a Block Error Rate (BLER) value.

According to an exemplary embodiment, at least some other access devices 215 may include logic of an exemplary embodiment of the adaptive resource control service. For example, a gNB, an eNB, or another type of wireless station may provide aspects of the adaptive resource control service. In one implementation, a model training function may reside in a non-real time (RT) RIC (e.g., in a Service Management and Orchestration (SMO) framework) and an inference model function may reside in a CU, DU, or a near-RT RIC.

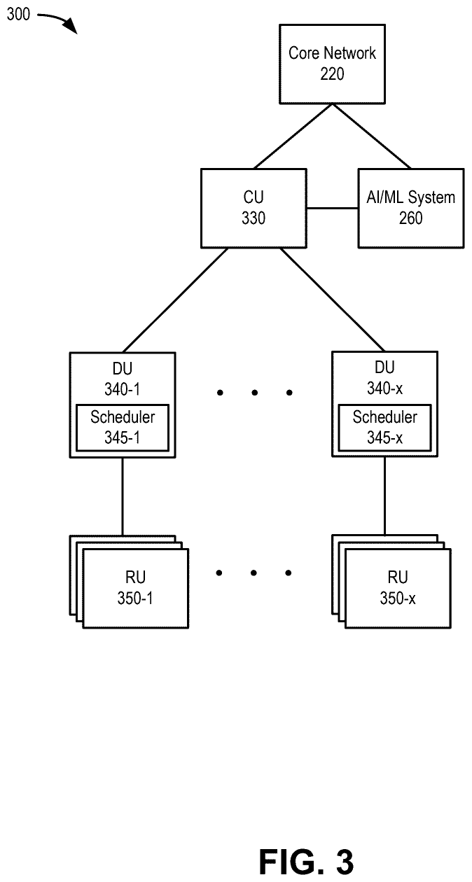

FIG. 3 is a diagram illustrating an exemplary portion 300 of environment 200 that may be used with the adaptive resource control service. As shown in FIG. 3, portion 300 may include a CU 330, DUs 340-1 through 340-x (also referred to collectively as DUs 340 and individually as DU 340), RU groups 350-1 through 350-x (also referred to collectively as RUs 350 and individually as RU 350), core network 220, and AI/ML system 260. Each of DUs 340 may include a corresponding scheduler 345-1 through 345-x (referred to collectively as schedulers 345 and individually as scheduler 345). AI/ML system 260 may be part of a RIC system, CU 330, or similar type of RAN controller device that uses AI-enabled policies and ML-based models to optimize network performance. According to implementations described herein, AI/ML system 260 may perform AI/ML-based modeling for the adaptive resource control service.

Devices (e.g., core devices 225) in core network 220 may perform UE-based authentication, authorization, and mobility management for end devices 150. In relation to the adaptive resource control service, core network 220 may identify end device types, and other profile information, associated with connected end devices 150 that may be applied by CU 330 and/or DUs 340 to implement an inference model for the adaptive resource control service (e.g., a model trained and provided by AI/ML System 260).

CU 330 may include a central unit for a gNB or another access device 215. In one implementation, CU 330 may conform to standards for an O-CU. CU 330 may control the transport of data (e.g., data packets) received via wireless RF transmissions from an end device 150 and may control the transport of data from a wireless network to a DU 340 for wireless transmission (e.g., via RUs 350) to a destination end device 150. CU 330 may be associated with multiple DUs 340. In some implementations, CU 330 may be divided into control plane (CP) and user plane (UP) components. The CU-CP includes a logical node that hosts Radio Resource Control (RRC) and other control plane functions (e.g., Service Data Adaptation Protocol (SDAP), Packet Data Convergence Protocol (PDCP), etc.). The CU-UP includes a logical node that hosts user plane functions, such as, for example, data routing and transport functions. In relation to the adaptive resource control service, CU 330 may identify poor signal performance in a zone/sub-sector based on reports from end device 150, such as signal quality measurement information that is below a particular quality threshold. For example, poor coverage may be implied or derived based on current (real-time) signal measurements from a connected end device 150, signal measurements by other end devices 150, or based on known signal propagation models.

DU 340 may include, in some implementations, a logical node that hosts functions associated with the Radio Link Control layer, the Medium Access Control (MAC) layer, and the physical layer (PHY). For example, DU 240 may conform to standards for an O-DU. In one implementation, DU 340 may identify loading conditions for a sector or zone/sub-sector, such as when loading conditions exceed a predetermined high-use threshold for the adaptive resource control service. In some implementations, the DU 340 may host scheduler 345 for managing use of physical resources for uplink and downlink signaling over a corresponding group of RUs 350.

Scheduler 345 may schedule use of resources (e.g., resource blocks in a physical layer) to optimize delivery of UL/DL traffic for end devices 150. According to one implementation, scheduler 345 may receive an indication of poor coverage for one or more connections (e.g., a 5G NR connection). Under direction of CU 330 or AI/ML system 260, for example, scheduler 345 may apply an inference model to prioritize users (e.g., end devices 150) for reduced resource block allocation and/or apply adaptive resource controls, as described further herein. In one implementation, scheduler 345 may adjust PDCCH grants to reduce power consumption in a zone 120.

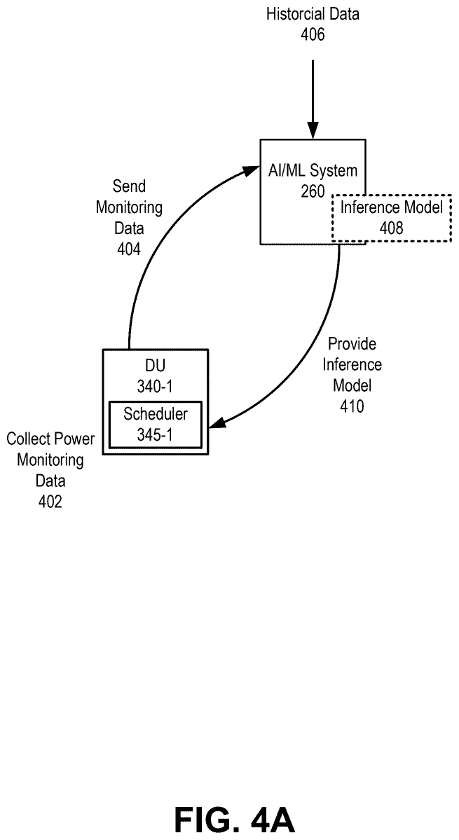

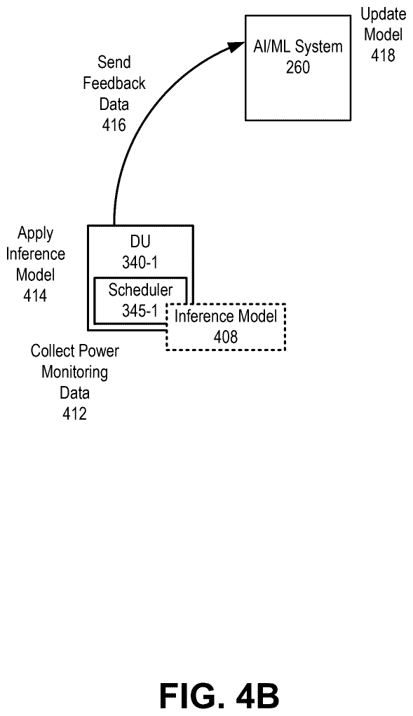

FIGS. 4A and 4B are diagrams illustrating communication among some devices of network portion 300 to implement modeling for the adaptive resource control service. As shown in FIG. 4A, DU 340-1 may collect monitoring data 402. For example, DU 340-1 may collect, for individual zones 120, power consumption level data, resource block usage data, and end device 150 performance data (e.g., accessibility data, retainability data, QoS data, etc.). As shown at reference 404, DU 340-1 may send the monitoring data to AI/ML system 260. For example, DU 340-1 may send the monitoring data periodically, in real time, or in near-real time.

AI/ML system 260 may receive the monitoring data from DU 340-1. As shown at reference 406, AI/ML system 260 may also receive or store historical data. The historical data may include a variety of historical records for individual zones 120/segments 115. Examples of types of historical data may include power consumption data, accessibility data, retainability data, or other performance data detectable to a per-device and/or per-zone level.

AI/ML system 260 may use, for example, a deep neural network to learn how to analyze the monitoring data and historical data (collectively referred to herein as training data) and make inferences, such as inferences for power consumption within a zone 120 or segment 115. AI/ML system 260 may generate, for example, an inference model 408. In some implementations, one or more components of the inference model 408 may include machine learning models, such as a deep learning neural network and/or another type of neural network. The inference model 408 may include multiple layers of nodes (or neurons) with a certain arrangement of connections between the nodes. Weights (i.e., numerical values) may be associated with the connections between the nodes. Each connection between nodes may have an associated weight that signifies a strength and direction (e.g., positive or negative) of the influence one node has on another. In other implementations, inference model 408 may include a K-nearest neighbors (KNN) classifier, a decision tree classifier, a naïve Bayes classifier, a support vector machine (SVM) classifier, tree based (e.g., a random forest) classifier using Euclidian and/or cosine distance methods, a logistic regression classifier, a linear discriminant analysis classifier, a quadratic linear discriminant analysis classifier, a maximum entropy classifier, a kernel density estimation classifier, a principal component analysis (PCA) classifier, a gradient boosting framework (e.g., XGBoost, LightGBM) and/or another type of classifier. Other configurations may be implemented.

AI/ML system 260 may eventually generate inference model 408 for a specific segment 115, which may be provided to DU 340-1 and to which new inference data (e.g., real-time power monitoring data, accessibility data, retainability data, end device performance data, etc.) for the adaptive resource control service may be applied (e.g., by DU 340-1). According to an implementation, AI/ML system 260 may work with multiple other DUs 340 to train and develop different inference models for different segments 115.

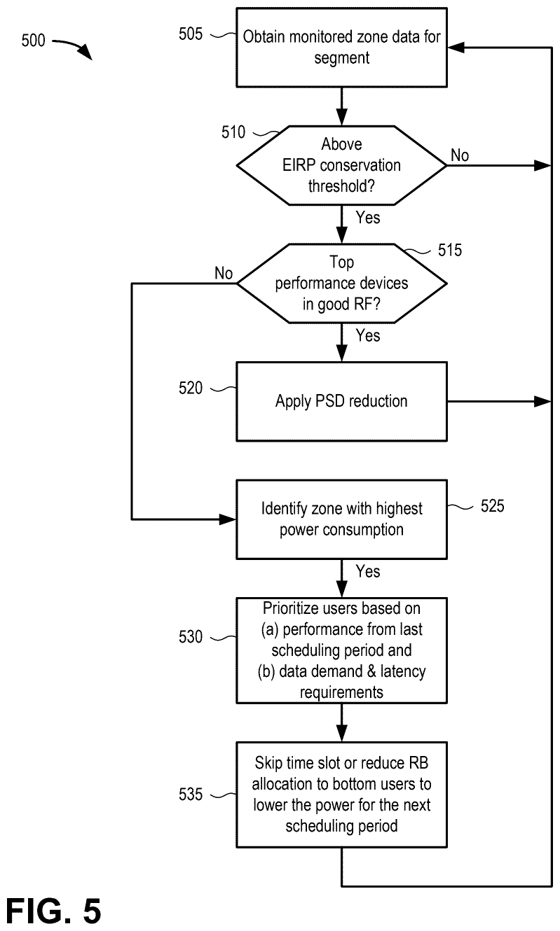

Referring to FIG. 4B, DU 340-1 may receive the inference model and continue to collect power monitoring data 412 (e.g., real time inference data). DU 340-1 may apply 414 inference model 408 to the collected power monitoring data 412 to obtain output, such as identifying end devices 150 with poor signal quality in relatively higher power consumption zones 120 and/or identifying end devices 150 with good signal quality in relatively lower power consumption zones 120. DU 340-1 may provide adaptive/directional resource control (e.g., via scheduler 345-1) across different zones 120 for the adaptive resource control service. Application of the directional resource control is described further below in connection with FIG. 5.

DU 340-1 may provide feedback 416, such as records of adaptive scheduling changes and resulting end device performance, to AI/ML system 260, which may be interpreted to indicate, for example, the accuracy/results of the inference model. Based on the feedback, AI/ML system 260 may update 418 the inference model.

FIG. 5 is a diagram illustrating an exemplary process 500 of an embodiment of the adaptive resource control service. More particularly, process 500 relates to resource controls for managing EIRP levels, according to an implementation. In the example of FIG. 5, process 500 may be implemented by access device 215. According to an exemplary embodiment, access device 215 may be implemented as a wireless station 110 (e.g., integrated or split), such as a gNB or a DU 340 within a gNB, for example. In other implementations, some or all of process 500 may be implemented by a CU 330, RU 350, a RIC, or another access device 215. For simplicity description of FIG. 5 refers to DU 340.

At block 505, DU 340 may monitor each zone 120 of a segment 115 for power consumption, resource (e.g., RB) usage, and end device performance. For example, DU 340 may track antenna transmit power, monitor PDCCH grant aggregation levels, and receive measurement reports from end devices 150. At block 510, DU 340 may determine if power consumption within a segment is above a configured segment threshold (referred to herein as an EIRP conservation threshold). For example, DU 340 may monitor the EIRP of segment 115 against an EIRP conservation threshold (e.g., 70%, 75%, 80%, or another value of the EIRP limit).

If the EIRP conservation threshold is reached (block 510-Yes), at block 515 DU 340 may determine if there are top performing devices in a zone with good RF strength. For example, DU 340 may receive signal measurement reports from end devices 150 and identify end devices 150 with strong DL signal strength measurements that can be serviced with less power. The measurement report values may identify an RSRP value, an RSRQ value, an RSSI value, an SINR value, a CQI value, a BLER value, and/or another type of KPI value included in a measurement report to indicate DL RF performance.

If there are top performing devices available (block 515—Yes), DU 340 at block 520 may apply PSD reduction and/or reallocate power within the segment. For example, DU 340 may reduce PSD for a zone that has low usage and high performance. Alternatively, DU 340 may transfer power from a zone (e.g., zone 120-2) that has low usage and high performance to a zone (e.g., 120-1) whose performance is challenging but still under the EIRP limits.

If no top performing devices are available (block 515—No) or after block 520, DU 340 may determine at block 525 a zone with a highest current power consumption. For example, DU 340 may determine a zone with the highest power level (e.g., transmit antenna power) above a configured zone threshold (referred to herein as a zone power consumption threshold). For example, DU 340 may identify when power consumption levels in a zone 120 exceed the zone power consumption threshold (e.g., 70%, 80%, or another loading value) and select the zone with the highest current/active power consumption.

If there is zone above the zone power consumption threshold (block 525—Yes), DU 340 at block 530 may prioritize users based on (a) performance from last scheduling period and (b) data demand and latency requirements. For example, user (e.g., end devices 150) with poor performance and high data demand/low latency requirements may be regarded as high impact users. These high impact users may be assigned temporary low priority, since the high amount of resources dedicated to these users provides a low probability of meeting necessary service levels (as indicated by the poor performance from the previous period). Accordingly, at block 535, DU 340 may skip scheduling time slot or reduce the resource block (RB) assignment for the lowest priority users to reduce the peak power on this specific zone.

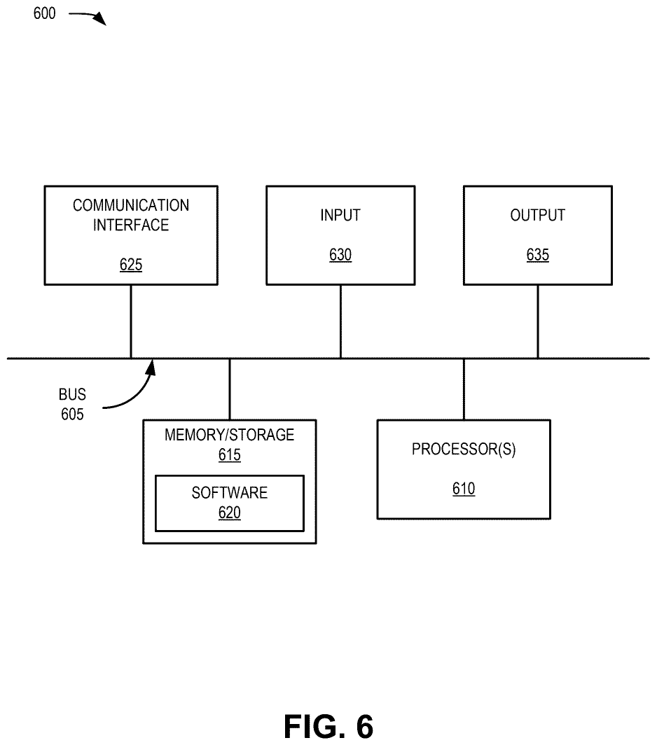

FIG. 6 is a diagram illustrating exemplary components of a device 600 that may be included in one or more of the devices described herein. For example, device 600 may correspond to end device 150, access device 215, core device 225, external device 235, CU 330, DU 340, and/or other types of network devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques including, for example, multithreading, parallel processing, pipelining, interleaving, learning, model-based, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 615 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, mass storage, off-line storage, or some other type of storing medium. Memory/storage 615 may store data, software, and/or instructions related to the operation of device 600.

Software 620 includes an application or a program that provides a function and/or a process. As an example, with reference to DU 340, software 620 may include an application that, when executed by processor 610, provides a function and/or a process of the adaptive resource control service, as described herein. According to another example, with reference to AI/ML system 260, software 620 may include an application that, when executed by processor 610, provides a function and/or a process of the adaptive resource control service, as described herein. Software 620 may also include firmware, middleware, microcode, hardware description language (HDL), and/or another form of instruction. Software 620 may also be virtualized. Software 620 may further include an operating system (OS) (e.g., Windows, Linux, Android, proprietary, etc.).

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard.

Input 630 permits an input into device 600. For example, input 630 may include a keyboard, a mouse, a display, a touchscreen, a touchless screen, a button, a switch, an input port, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, deleted, or some other operational state during its life cycle (e.g., refreshed, paused, suspended, rebooted, or another type of state or status), using well-known virtualization technologies. For example, access device 215, core device 225, external device 235, and/or another type of network device or end device 150, as described herein, may be a virtualized device.

Device 600 may be configured to perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions stored by memory/storage 615 may configure device 600 and/or cause processor 610 to perform a function or a process described herein. Alternatively, for example, according to other implementations, device 600 may be configured to perform a function or a process described herein based on the execution of hardware (processor 610, etc.).

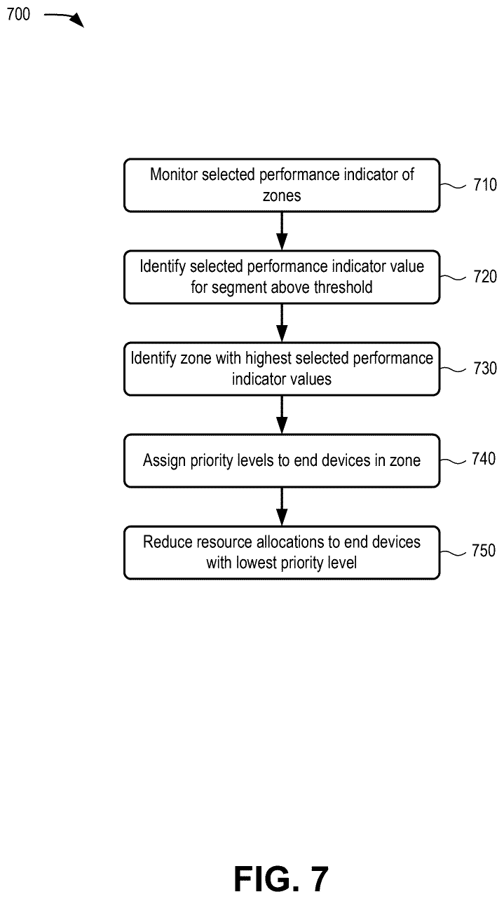

FIG. 7 is a flow diagram illustrating an exemplary process 700 of an exemplary embodiment of the adaptive resource control service. According to an exemplary embodiment, process 700 may be implemented by access device 215. According to an exemplary implementation, a processor may execute software to perform a step (in whole or in part) of process 700, as described herein. Alternatively, a step (in whole or in part) may be performed by execution of only hardware.

Process 700 may include monitoring for a selected performance indicator of zones in a cell segment (block 710). For example, DU 304 may receive and track power consumption data (e.g., antenna transmit power), resource usage data (e.g., scheduling of RBs), and end device 150 performance data for each zone 120 in a segment 115.

Process 700 may include identifying that the cell segment has a selected performance indicator value above a first threshold (block 720) and identifying a first zone, of the zones, having a highest selected performance indicator value (block 730). For example, based on the monitoring data, DU 340 may detect that an EIRP level is approaching a configured threshold (e.g., 70% of EIRP limit). From the monitoring data, DU 340 may also detect a zone 120 with the highest transmit antenna power.

Process 700 may further include assigning priority levels to end devices within the first zone (block 740) and reducing, over a next scheduling period, resource allocations to end devices with a lowest priority level of the priority levels (block 750). For example, DU 340 assign low priority to end devices 150 with applications that have high service demands (e.g., high data requirements and/or low latency requirements) that are unlikely to be achieved in the next scheduling interval. DU 340 may skip or reduce resource allocations to the lowest priority end devices 150 during a next scheduling period.

FIG. 7 illustrates exemplary steps or operations of process 700, however, according to other exemplary embodiments, process 700 may include additional, different, and/or fewer steps or operations than those illustrated and described in relation to FIG. 7. For example, according to other exemplary embodiments, DU 304 may also apply a PSD reduction in a different zone of the cell segment when an average of the monitored power consumption is above a second threshold, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 5 and 7, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
monitoring, by a network device, a selected indicator for zones in a cell segment;
identifying, by the network device, that the cell segment has a selected performance indicator value above a first threshold;
identifying, by the network device, a first zone, of the zones, having a highest selected performance indicator value;
assigning, by the network device, priority levels to end devices within the first zone; and
reducing, by the network device, during a next scheduling period, resource allocations to end devices with a lowest priority level of the priority levels.

2. The method of claim 1, wherein the monitoring further includes:
monitoring resource usage for the zones and performance of end devices within the zones.

3. The method of claim 1, wherein identifying that the cell segment has the selected performance indicator value above a first threshold includes identifying an Effective Isotropic Radiated Power (EIRP) for the cell segment.

4. The method of claim 1, further comprising:
applying a power spectral density (PSD) reduction in a second zone, of the zones, of the cell segment when the selected performance indicator value is above a second threshold.

5. The method of claim 1, wherein assigning the priority levels includes:
assigning a priority level based on end device performance from a previous scheduling period and based on data demands or latency requirements.

6. The method of claim 1, wherein the priority levels assign lower priority to end devices with poor performance from a previous scheduling period.

7. The method of claim 1, wherein the priority levels assign lower priority to end devices with high data demands or low latency requirements.

8. The method of claim 1, wherein reducing the resource allocations includes skipping time slot resource allocations for the end devices with the lowest priority level.

9. The method of claim 1, wherein the network device is a Distributed Unit (DU) of a Radio Access Network (RAN).

10. A network device comprising:
a processor, wherein the processor is configured to:
monitor a selected indicator for zones in a cell segment;
identify that the cell segment has a selected performance indicator above a first threshold;
identify a first zone, of the zones, having a highest selected performance indicator;
assign priority levels to end devices within the first zone; and
reduce, during a next scheduling period, resource allocations to end devices with a lowest priority level of the priority levels.

11. The network device of claim 10, wherein, when monitoring the power consumption, the processor is further configured to:
monitor resource usage for the zones and performance of end devices within the zones.

12. The network device of claim 10, wherein, when identifying that the cell segment has the selected performance indicator value above a first threshold, the processor is further configured to:
identify an Effective Isotropic Radiated Power (EIRP) for the cell segment.

13. The network device of claim 10, wherein the processor is further configured to:
apply a power spectral density (PSD) reduction in a second zone, of the zones, of the cell segment when the selected performance indicator value is above a second threshold.

14. The network device of claim 10, wherein, when assigning the priority levels, the processor is further configured to:
assign a priority level based on end device performance from a previous scheduling period.

15. The network device of claim 10, wherein, when assigning the priority levels, the processor is further configured to:
assign lower priority to end devices with poor performance from a previous scheduling period.

16. The network device of claim 10, wherein, when reducing the resource allocations, the processor is further configured to:
skip time slot resource allocations for the end devices with the lowest priority level.

17. A non-transitory computer-readable storage medium storing instructions executable by a processor of a network device, wherein the instructions are configured to:
monitor a selected indicator for zones in a cell segment;
identify that the cell segment has a selected performance indicator above a first threshold;
identify a first zone, of the zones, having a highest selected performance indicator;
assign priority levels to end devices within the first zone; and
reduce, over a next scheduling period, resource allocations to end devices with a lowest priority level of the priority levels.

18. The non-transitory computer-readable storage medium of claim 17, wherein the instructions to assign the priority levels are further configured to:
assign a priority level based on end device performance from a previous scheduling period.

19. The non-transitory computer-readable storage medium of claim 17, wherein the instructions to assign the priority levels are further configured to:
assign a priority level based on data demands or latency requirements of the end device.

20. The non-transitory computer-readable storage medium of claim 17, wherein the instructions to identify that the cell segment has a selected performance indicator above a first threshold are further configured to:
identifying an Effective Isotropic Radiated Power (EIRP) for the cell segment.
